(19) United States
(12) Patent Application Publication
(10) Pub. No.: US 2005/0257873 A1
(43) Pub. Date: Nov. 24, 2005

(54) Method for making thin-edge boards, based on hydraulic binders, line and device for producing same

(75) Inventors: Roger Arese, Isle Sur La Sorgue (FR); Giovanni Barcaro, Popoli (PE) (IT); Paul Jallon, Bordeaux (FR); Serge Ratouchniac, Septemes Les Vallons (FR); Dominique Ribas, Monteux (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: LAFARGE PLATRES, Avignon Cedex 9 (FR)

(21) Appl. No.: 10/521,756

(22) PCT Filed: Jul. 18, 2003
(86) PCT No.: PCT/FR03/02281

§ 371 Date: Jan. 19, 2005

(30) Foreign Application Priority Data
Jul. 19, 2002 (EP) 02291838.7

(51) Int. Cl. B28B 1/00

(52) U.S. Cl. 156/39; 156/346

(57) ABSTRACT

A production process for boards (9b,11), based on a hydraulic binder such as plaster, having thinned edges (10). This process, before the passage into the die (4, 403), the extraction of a lath (6, 23) from a lath magazine (20) and the introduction of this lath (6, 23) under the facing material (1) of the board. A production line for such boards (9b,11) as well as a device for the introduction of laths (6,23) under the facing material (1).

The present invention relates to a production process for boards based on hydraulic binder such as plaster, these boards having thinned edges.

The invention also relates to a production line for such boards as well as a device that can be used in order to produce these boards.

It has long been known to realize thinned longitudinal edges on plaster boards. In fact, U.S. Pat. No. 1,754,429 and British patent no. 429 379 already proposed, respectively in 1922 and in 1934, techniques for the continuous production of plaster boards having thinned longitudinal edges.

The existence of thinned edges makes possible a satisfactory assembly of two adjacent plaster boards. It allows the space left by the thinned edges to be filled by means of a joining coat, that can then be made level with the surface of the boards, without creating increased thickness. In addition, it reduces the risk of cracking between the boards.

The thus-realized assembly of several boards constitutes a continuous surface having a good surface smoothness.

In 1937, U.S. Pat. Nos. 2,238,017 and 2,246,987 attempted to solve the problem of the realisation of thinned transverse edges.

The solution that the first of these patents proposes is to make a transverse groove in the lower sheet of paper by folding this latter before the pouring of the plaster composition and the arrival on the conveyor belt. As the transverse groove projects vis-à-vis the lower sheet of paper, it creates, once the paper sheet is on the conveyor belt, a cavity the walls of which are skewed. By then cutting the board at the end of each skewed part, two boards with thinned transverse edges are obtained.

Such a solution is difficult to put into practice as it necessitates the installation of special rollers for the realization of the groove. Moreover, the board must be cut in two places, which has the added drawback of producing a significant quantity of waste.

The solution proposed by the second American patent cited above (U.S. Pat. No. 2,246,987) involves fixing lateral bars transversely on the conveyor belt of the continuous production line for plaster boards. This solution presents the drawback of necessitating the stopping of the production line each time it is wished to modify the length of the plaster boards to be produced. These stoppages are long, as the bars on the conveyor belt have to be removed in order to shift them, then fixed again. Then, it is necessary to restart the whole of the plaster boards production line.

Such a solution is therefore difficult to put into practice and involves high costs.

Although many years have passed since the publication of these patents, no technique has emerged that provides a satisfactory solution to the problem of the realization on a continuous line of plaster boards with thinned transverse edges.

This is surprising when the advantages brought by such boards are known and when it is known that the use of plaster boards is constantly spreading throughout the world.

The object of the invention is therefore to propose a process permitting the production of plaster boards with thinned transverse edges. This process succeeds in remedying the drawbacks of the techniques proposed in the prior art.

More precisely, the invention relates to a production process for a board based on hydraulic binder, with thinned edges, in which:
1) a composition of hydraulic binder is poured onto a facing material,
2) the coated material obtained is passed into a die (4) so as to obtain a preform,
3) the hydraulic setting of the composition of hydraulic binder is allowed to take place, and
4) the preform is cut, this process being characterized in that
a) it also comprises the following steps:
before step 2), a lath is extracted from a lath magazine, the length of which lath is approximately at least equal to the width of the facing material and this lath is introduced under the said facing material;
after step 3), the said lath is withdrawn; and in that
b) the cutting of step 4) is carried out at the narrowed section created by the lath.

The subject-matter of the invention is also a production line for boards, based on hydraulic binder, having thinned edges, from a preform comprising at least a facing material covered with a composition of hydraulic binder, this production line comprising a die, as well as, upstream from this die, means for introducing, under the facing material, a lath the length of which is approximately at least equal to the width of the facing material.

Finally, the invention also provides a device for the introduction of laths under a facing material, with a view, in particular, to producing boards based on hydraulic binder, having thinned edges, this device comprising:
a lath magazine;
at least one lath,
means for extracting one lath at a time from the lath magazine;
means for receiving the extracted lath;
means for displacing the extracted lath in a direction parallel to its length;
means for supporting the displaced lath; and
means for moving the displaced lath in a direction parallel to its width;
and being characterized in that it also comprises means for coating with glue at least a part of the upper face of the lath.

Other characteristics and advantages of the invention will now be described in detail in the following description which is given with reference to the figures, in which

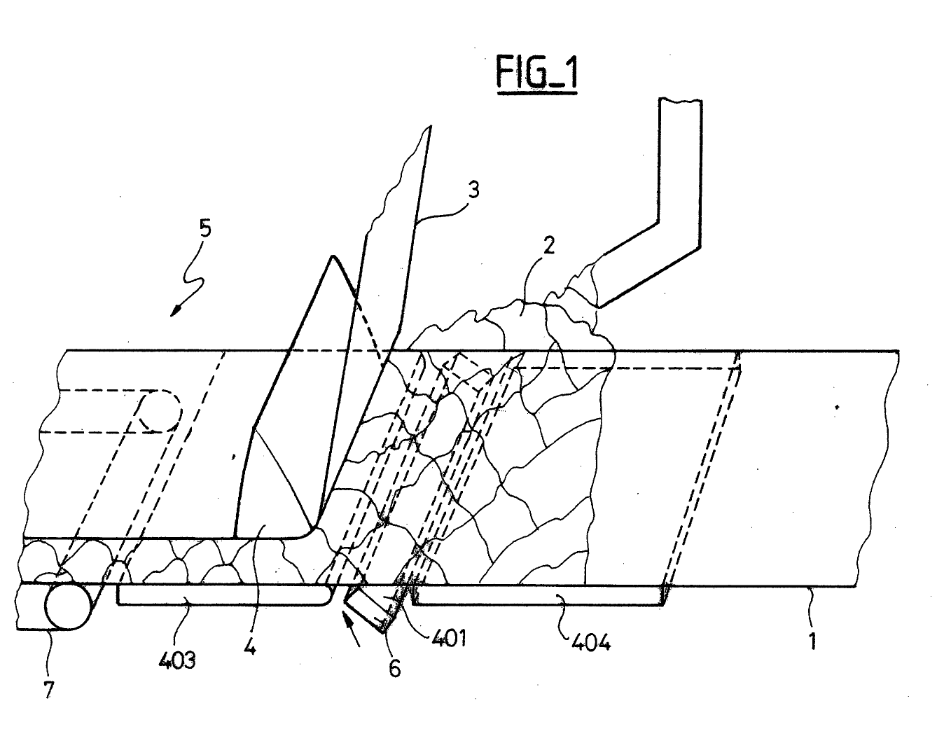

FIG. 1 represents schematically the introduction of the lath under the facing material;

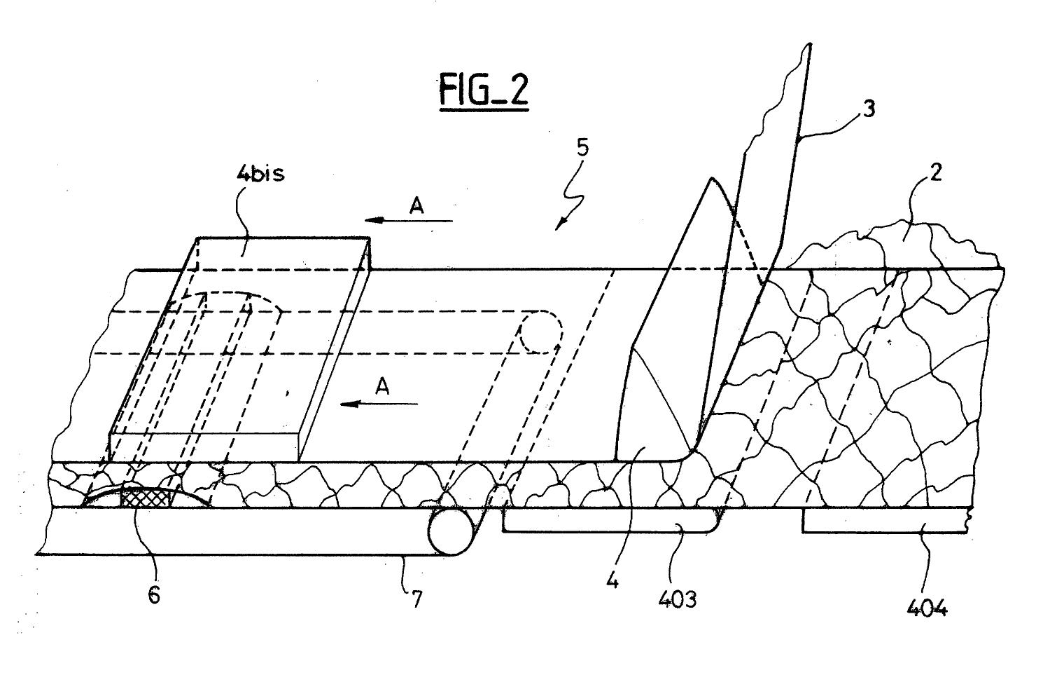

FIG. 2 represents schematically the movement of the preform accompanied by a lath;

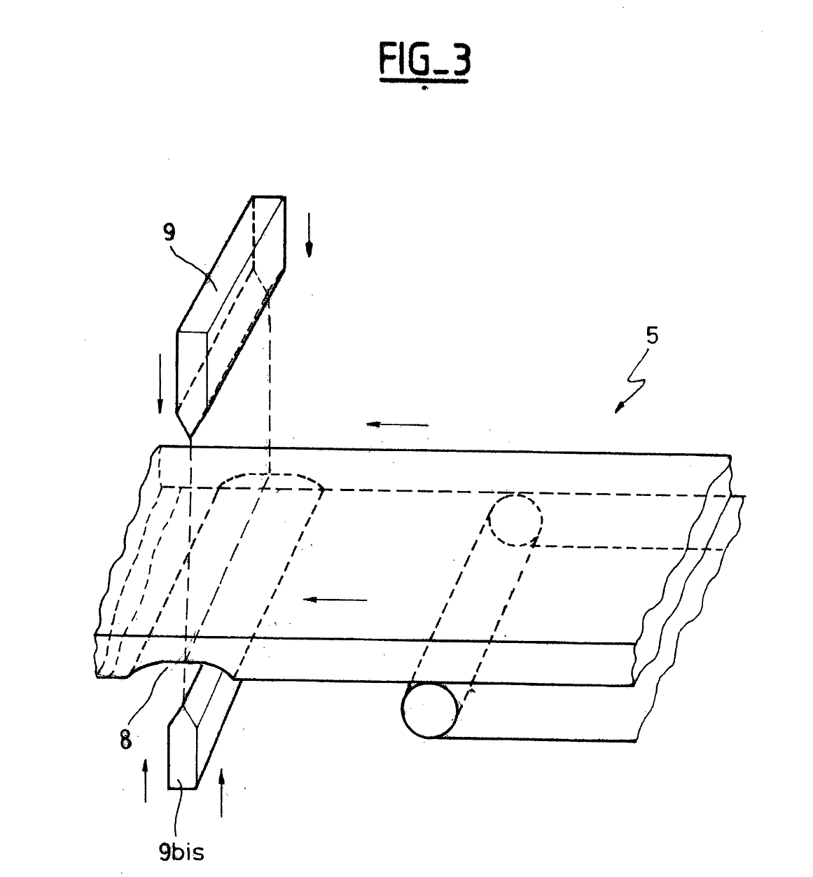

FIG. 3 represents schematically step b) of the process according to the invention;

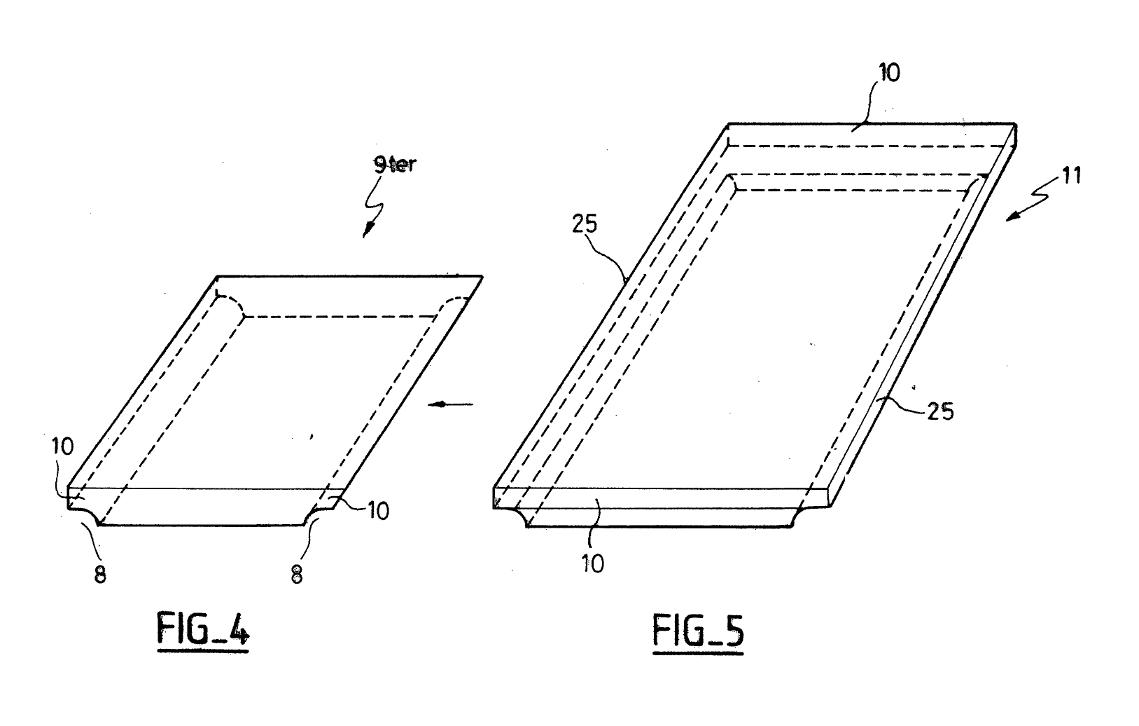

FIG. 4 represents a board as obtained by the process according to the invention;

FIG. 5 represents a board obtained by the process according to a preferred embodiment of the invention;

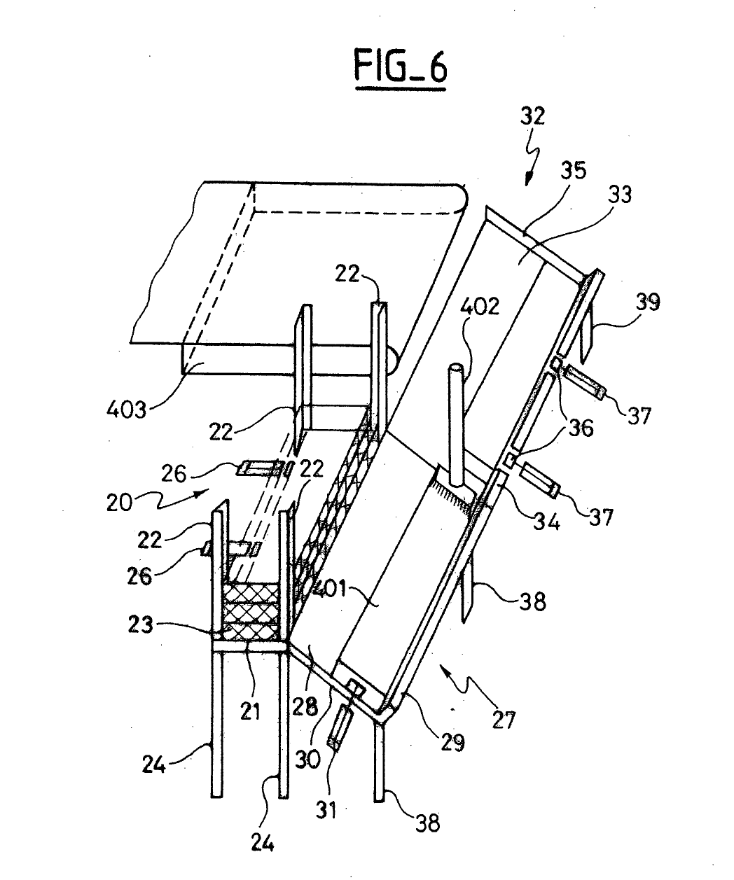

FIG. 6 represents, schematically and in perspective, a part of the production line according to the invention;

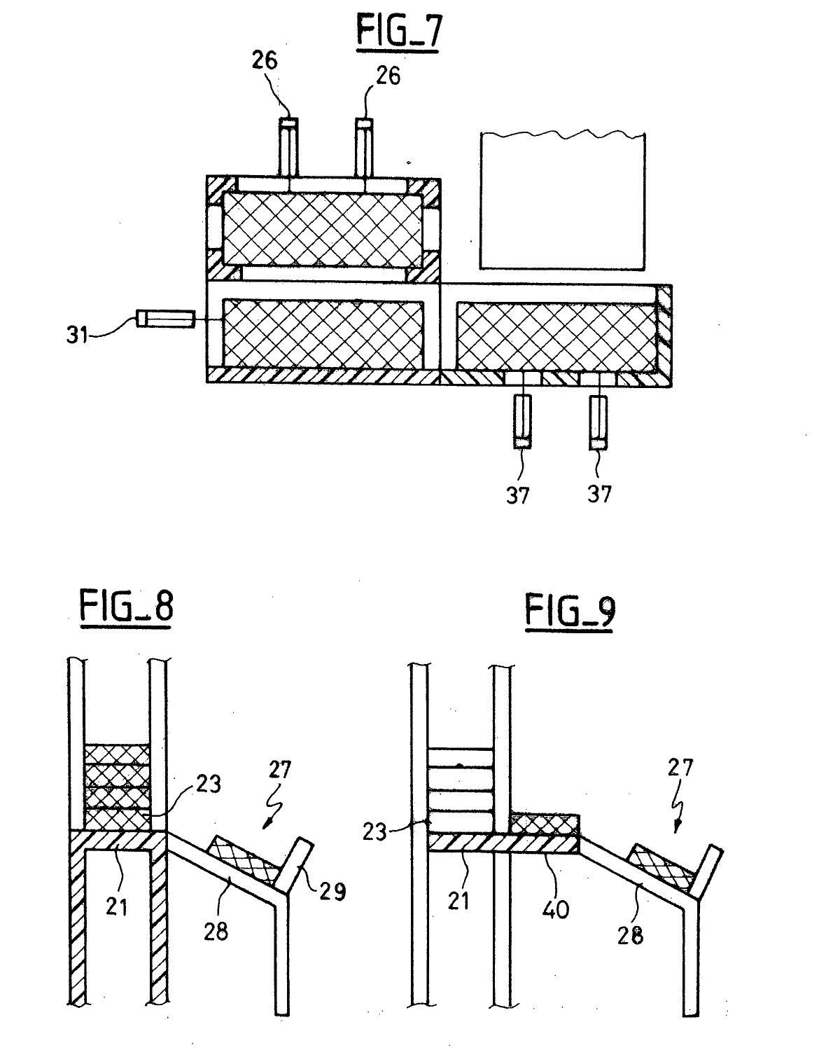

FIG. 7 represents, schematically and seen from above, the device according to the invention;

FIG. 8 represents, schematically and seen from the side, the device according to the invention;

FIG. 9 represents, schematically and seen from the side, a variant of the device according to the invention; and

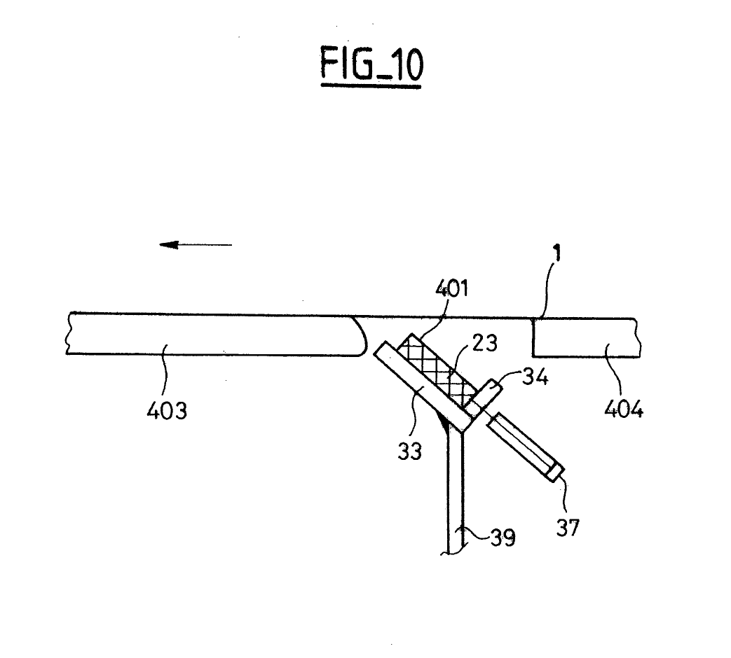

FIG. 10 represents, schematically and in section, a detail of the device of FIG. 6, illustrating the introduction of a lath under the facing material; and

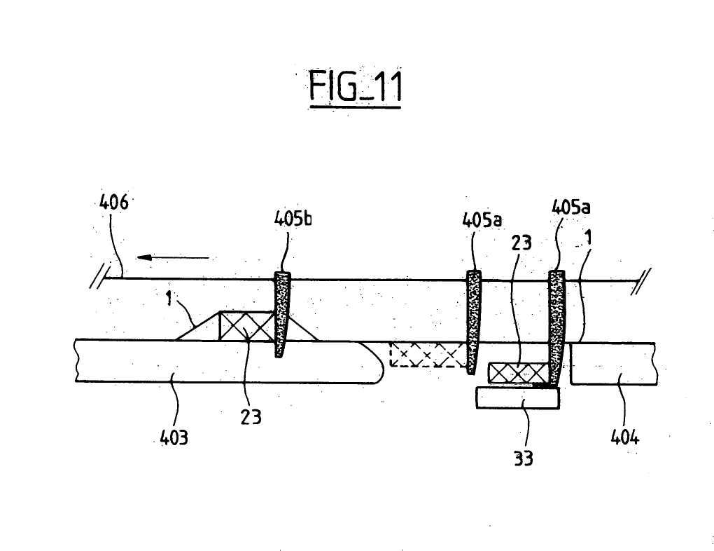

FIG. 11 represents, schematically and in section, a variant of the device according to the invention.

### DETAILED DESCRIPTION OF THE INVENTION PROCESS ACCORDING TO THE INVENTION

By “transverse edges” is meant in the present description the edges that are perpendicular to the direction of displacement of the conveyor belt in a production line for boards based on hydraulic binder.

Referring to FIG. 1, a production line is seen for boards produced by pouring a composition of hydraulic binder 2 onto a facing material 1 and, generally, covering by a second facing material 3. Passing the assembly into the die comprising the forming plate (English term) 4 and the board 403 gives a preform 5. However, there could be alternatives to these boards, in particular the board 403 could be replaced by a “mini-strip”.

The hydraulic binder composition preferably comprises plaster.

The facing materials 1 and 3 can be constituted by sheets of paper or of board, of glass mats or of any material known to a person skilled in the art as being able to serve as facing material.

Before passing the facing material coated with the hydraulic binder composition into the die or into the equivalent device used in the production line (for example, a roll called “master roll” in English), a lath 6 is introduced between the facing material 1 and the board 403. This board 403 may have been obtained by cutting a piece off a board 404 so as to create the board 403 and, between this latter and the remainder of the board 404, a space for the introduction of the lath 6.

The introduction of the lath can be realized upstream from, in or downstream from the pouring zone.

The terms “upstream” and “downstream” refer to the direction of travel of the preform 5.

It is carried out in such a way that the longitudinal axis of the lath 6 is approximately perpendicular to the direction of travel of the conveyor belt 7.

As can be seen in FIG. 2, the lath 6 is then carried along by the facing material 1 and the conveyor belt 7. The hydraulic setting and the hardening of the plaster composition 2 then take place along the whole of the distance travelled by the preform 5, indicated by the arrows A.

The upper face 401 of the lath 6, that is to say the one intended to come into contact with the facing material 1 (see FIG. 1), can be at least partially coated with a glue allowing it to adhere to the facing material 1, in particular when the introduction of the lath is realized upstream from the pouring zone.

According to a preferred embodiment of the invention, the withdrawal of the lath 6 takes place before the cutting of the preform 5.

Thus, after a certain time, to which a distance travelled by the preform 5 on the conveyor belt 7 corresponds, that a person skilled in the art can determine in relation to the speed of travel of the conveyor belt 7 and to the setting time of the plaster composition 2, the hardness of the preform 5 is sufficient to allow the lath 6 to be withdrawn without deforming the preform 5 and without the plaster composition 2 filling the space or narrowed section 8 (FIG. 3) left by the withdrawal of the lath 6.

The withdrawal of the lath 6 can be carried out in any suitable manner.

It can take place, quite simply, by the fall of the lath 6 due to its weight, this fall being able to take place, for example, in the space situated between two rollers constituting the system of conveyor belts which, in general, is not continuous for the whole length of the production line, but is formed by several belts driven by rollers between which are free spaces.

The withdrawal of the lath 6 can also take place by means of a blade or a brush (not represented) scraping the lower face of the facing material 1 to which the lath 6 adheres at a suitable point, for example, in the space between two rollers mentioned in the previous paragraph.

After the withdrawal of the lath 6, the preform 5 continues to move, still carried along by the conveyor belt 7, and the hardening of the plaster composition 2 proceeds.

As can be seen in FIG. 3, when the narrowed section 8 reaches the height of the cutting device generally constituted by two opposed knives 9 and 9a, this device starts up and cuts the preform 5. A board 9b is thus obtained, visible in FIG. 4, the length of which is defined by the distance travelled by the conveyor belt between two cutting operations, that is to say, according to the invention, by the distance travelled by the conveyor belt between two consecutive narrowed sections 8. This board 9b therefore presents two thinned transverse edges 10.

The cutting device is preferably adjusted so that the knives 9 and 9a cut the preform 5 approximately in the middle of the narrowed section 8.

The size of each narrowed section 8 depends on the dimensions of the lath 6. This latter is in general a parallelepiped the thickness of which is generally between 0.5 and 4 mm, preferably between 1.5 and 4 mm. Its width is generally between 5 and 20 cm and its length is approximately equal to the width of the facing material 1.

It can optionally be provided that the width of the lath 6 is less than that of the facing material 1, in particular when longitudinal strips (called << tape >> in English) are used.

It is not very important what material constitutes the laths 6, from the moment it allows these laths to resist the weight of the preform thickness of the preform 5 which is situated above each lath 6. This can therefore be a plastic material, wood, metal, board, etc. presenting a good resistance to wear and stability over time.

According to a preferred embodiment of the invention, the process which has just been described supplements a known production process for plaster boards having two thinned longitudinal edges. This latter generally provides for the introduction of a strip, generally of plastic, generally called << tape>>, on each longitudinal side of the conveyor belt 7. Such a process is described for example in European patent application no. 482 810.

This thus allows a board based on hydraulic binder 11 to be obtained, as illustrated in FIG. 5, having, apart from its two thinned transverse edges 10, two thinned longitudinal edges 25, that is four thinned edges in total.

It goes without saying that if the frequency of the cutting operations is double that of the introduction of the laths 6, boards are obtained that have three thinned edges (two longitudinal and one transverse).

The length of the produced plaster boards depends of course on the speed of travel of the conveyor belt and on the frequency of the cutting operations.

The frequency of the cutting operations is generally directly linked to the frequency of introduction of the laths, as the general aim is to obtain boards having two thinned transverse edges.

Thus, the process according to the invention is very flexible since, to change the length of the produced boards, it is enough simply to modify the frequency of introduction of the laths.

It is also possible to provide for the presence of a smoother 4a of standard type downstream from the place where the lath 6 is introduced (see FIG. 2).

Production Line for Boards Based on Hydraulic Binder

Represented in FIG. 6 is a part of a production line for boards based on hydraulic binder implementing the process according to the invention.

There can thus be seen a lath magazine 20 formed of a horizontal rectangular surface 21 from the corners of which rise, vertically and parallel, four angular pieces 22, in angle iron form and turned towards one another, so as to frame a pile of laths 23.

The dimensions of this lath magazine 20 are such that it can store a large number of laths 23 (see also FIGS. 7 and 8).

The horizontal surface 21 of the lath magazine 20 is supported by feet 24.

Arranged in parallel at the level of the first lath 23, that is to say the one situated right at the bottom of the pile, are two jacks 26, which are oriented so as to extract the first lath 23 from the pile by pushing it and making it slide towards an inclined plane 27 constituted by a downwardly inclined surface 28 and a rim 29 in its lower part to hold the lath which has just been extracted and to guide it subsequently.

At the level of the transverse side 30 of the inclined plane 27, that is to say the side opposite the board 403, a jack 31 is arranged parallel to the longitudinal axis of the inclined plane 27, in such a way that the operation of this jack 31 can give an impetus to the lath which has just been extracted from the lath magazine 20. The thus-propelled lath can then move by sliding parallel to the longitudinal axis of the inclined plane 27, the rim 29 of which guides it, towards a second inclined plane 32 which prolongs the first inclined plane 27, on the transverse side opposite the side 30.

According to an embodiment, means 402 are provided, for example between the first inclined plane 27 and the second inclined plane 32, for coating with glue at least partially the upper face 401 of the laths 23. These means 402 can be constituted, for example, by a brush 402 situated above a lath 23, when this lath is on the first inclined plane 27. The displacement of the lath 23 from the first inclined plane 27 towards the second inclined plane 32 allows the brush 402 to coat at least partially the upper face 401 of the lath 23 with a glue which then allows it to adhere to the facing material.

The second inclined plane 32 is likewise constituted by an inclined surface 33 fitted with a rim 34 in its lower part. It further comprises a stop 35 at its end opposite the jack 31, this stop being generally constituted by a pneumatic shock-absorber and being intended to put an end to the displacement of the lath propelled by the jack 31.

The rim 34 is fitted with openings 36 facing which are arranged two jacks 37 oriented so as to propel the lath positioned on the second inclined plane 32 towards the top of the inclined surface 33.

The first inclined plane 27 and the second inclined plane 32 are supported by feet, respectively, 38 and 39.

According to a variant that can be seen in FIG. 9, a plane surface 40 is provided parallel to the surface 23, between this latter and the first inclined plane 27 to support horizontally a lath extracted from the lath magazine 20 before its descent onto the inclined surface 28 of the first inclined plane 27.

Thus, as can be seen in FIG. 10, the height of the feet 24, 38 and 39 is chosen such that a lath positioned on the second inclined plane 32 is at a lower height than that of the preform 5.

In general:
the longitudinal axis of the rim 34 of the second inclined plane 32 is perpendicular to the longitudinal axis of the board 403 (or conveyor belt 7);
the means 32, 33, 34, 35 for supporting the displaced lath are situated facing the start of the board 403; and
the inclined surface 33 of the second inclined plane 32 is adjacent to the board 403.

The length of the second inclined plane 32 is at least equal to that of the lath 23, that is to say at least equal to, and preferably greater than, the width of the preform 5.

In this way, as can be understood by referring to FIG. 10, when the jacks 37 are actuated, the lath on the second inclined plane 32 is pushed towards the top of the inclined surface 33, that is to say towards the board 403 and the facing material 1, and is wedged between these latter and entrained by them.

Of course, it can be provided that the laths are arranged other than by being piled in the lath magazine. They can for example be arranged side by side or according to any suitable arrangement allowing them to be extracted individually from the lath magazine.

The production line according to the invention generally includes electronic means which regulate its functions and permit, where applicable, control between them of implementing the different operations.

These electronic means provide that after the introduction of a lath under the preform by operation of the jacks 27, the jack 31 is actuated in order to introduce a new lath onto the second inclined plane 32, then the jacks 26 are actuated in order to introduce another lath onto the first inclined plane 27, and so on. The electronic means can vary the frequency of these operations in order to reduce or increase the length of the plaster boards with thinned edges produced.

According to another variant, particularly suited to the use of laths having a length greater than the dimension of the facing material, the production line includes means of accelerating the lath and/or means of accompanying the lath while it is in the die. These means are represented in FIG. 11 by fingers (405a, 405b) , which are placed on a motorized belt 406, the speed of which is approximately equal to that of the facing material. In operation, in a first step the means (32, 33, 34, 35), initially inclined, are moved, for example with the help of jacks, into an approximately horizontal position. A first finger (405a) then comes to rest on the lath, at its ends. The lath is then carried along towards the die, through an acceleration zone of for example a few cm or more, such that, upon contact with the facing material, the relative speed of the lath vis-à-vis the facing material is very low, even nil. This moment of the contact is represented by dotted lines in the figure. This allows tears in the facing material to be prevented. Once the lath (6, 23) is in contact with the facing material and engaged in the die, the means (32, 33, 34, 35) are restored to their inclined initial position. These means (32, 33, 34, 35) and their alternating movement are represented in FIG. 11 only in the raised position. The finger then continues its trajectory, and FIG. 11 thus also represents an intermediate state. In this state, the lath 23 is in contact with the facing material, and slides on the lower part of the die. The lath is carried along by the finger (405b) at a speed which is that of the facing material. The friction forces between the lath and the lower part of the die are therefore fully compensated by the action of the finger. This allows a perfect placement of the laths along the facing material to be ensured, whatever the speed of travel of the material, while preventing the skewed placement of the laths. At the outlet from the die, the lath 23 and the material are, as above, taken up on the conveyor belt. At this stage, the fingers are retracted and return via the belt to the handling zone of the laths. The cycle can then recommence.

Device According to the Invention

The means 20 to 22, 24 to 39 and 402 or 405 and 406 which have just been described can be combined in a device according to the invention.

The principal advantage of such a device is that it can be installed close to a standard production line for boards based on hydraulic binder with which it can then cooperate with a view to the putting into practice the process according to the invention.

The length of the lath can be approximately equal (up to 1% difference) to or smaller (between 1 and 10%, preferably between 2 and 5%) than or greater (between 1 and 50%, preferably between 2 and 30%) than the width of the facing material.

1. A production process for a board, based on hydraulic binder with thinned edges the method comprising:
1) pouring a composition of hydraulic binder onto a facing material (1),
2) passing the coated material obtained into a die so as to obtain a preform,
3) allowing the hydraulic setting of the composition of hydraulic binder to take place, and
4) cutting the preform,
a) the method also comprises the following steps:
before step 2), extracting a lath from a lath magazine the length of which lath is less than, approximately equal to or greater than the width of the facing material and this lath is introduced under the said facing material;
after step 3), withdrawing the said lath; and
b) the cutting of step 4) is carried out at the narrowed section created by the lath.

2. The process according to claim 1, in which the introduction of the lath is realized upstream from the pouring zone of the composition of hydraulic binder.

3. The process according to claim 1, in which the introduction of the lath is realized in or downstream from the pouring zone of the composition of hydraulic binder and before the passage of the said coated facing material into the die.

4. The process according to claim 1, further comprising a step of coating a part at least of the upper face of the lath by means of a glue.

5. The process according to one of claim claim 1, further comprising a step of acceleration of the lath up to a speed approximately equal to that of the facing material.

6. The process according to claim 1, also comprising a step of accompanying the lath during the passage into the die.

7. The process according to one of claim claim 1, wherein the cutting of step 4) takes place after the withdrawal of the lath.

8. The process according to one of claims claim 1, wherein the cutting of the board based on hydraulic binder is carried out approximately in the middle of the narrowed section

9. The process according to one of claims claim 1, wherein the said lath has a thickness ranging from 0.5 to 4 mm.

10. The process according to claim 1, wherein the said lath has a width of between 5 and 20 cm.

11. The process according to claim 1, wherein the conveyor belt supports two lateral strips on each of its longitudinal sides.

12. The process according to one of claims claim 1, wherein the method also comprises, between step 1) and step 2), a step of covering the composition of hydraulic binder by means of a second facing material.

13. The process according to claim 1, wherein the hydraulic binder comprises plaster.

14. A production line for boards based on hydraulic binder, having thinned edges from a preform comprising at least a facing material covered with a composition of hydraulic binder the production line comprising a die as well as, upstream from this die, means for introducing, under the facing material a lath the length of which is approximately at least equal to the width of the facing material.

15. The production line for boards of hydraulic binder according to claim 14, wherein the means are situated upstream from the pouring zone of the composition of hydraulic binder.

16. The production line for boards of hydraulic binder according to claim 14, wherein the means are situated in or downstream from the pouring zone of the composition of hydraulic binder.

17. The production line for boards based on hydraulic binder according to claim 14, also comprising means for coating with glue at least a part of the upper face of the lath.

18. The production line for boards based on hydraulic binder according to claim 14, also comprising means of acceleration of the lath up to a speed approximately equal to that of the facing material.

19. The production line for boards based on hydraulic binder according to claim 14, also comprising means (405, 406) of accompanying the lath during passage into the die.

20. The Production line for boards of hydraulic binder according to claim 14, comprising:
a lath magazine,
at least one lath;
means for extracting one lath at a time from the lath magazine;
means for receiving the extracted lath;
means for displacing the extracted lath in a direction parallel to its length;
means for supporting the displaced lath; and
means for sliding the lath under the facing material.

21. The production line for boards based on hydraulic binder according to claim 20, in which:
the means for receiving the extracted lath include an inclined surface fitted in its lower part with a rim;
the means for supporting the displaced lath in an inclined position include an inclined surface fitted in its lower part with a rim and on one side with a stop.

22. The production line for boards based on hydraulic binder according to claim 21, in which:
the longitudinal axis of the rim is perpendicular to the longitudinal axis of the conveyor belt;
the means for supporting the displaced lath are situated facing the start of the board; and the inclined surface is adjacent to the board.

23. The production line for boards of hydraulic binder according to claim 14, comprising:
a lath magazine,
at least one lath;
means for extracting one lath at a time from the lath magazine
means for supporting the lath; and
means for accelerating the lath up to approximately the speed of the facing material and means for accompanying the lath during its passage into the die.

24. The production line for boards based on hydraulic binder according to claim 23, in which the means include fingers arranged on a motorized belt.

25. The production line for boards based on hydraulic binder according to claim 23, in which the means include an inclinable surface, preferably fitted in its lower part with a rim, the said inclinable surface being able to occupy an inclined position and an approximately horizontal position.

26. The production line for boards based on hydraulic binder according to claim 14, wherein the production line also comprises means of covering the composition of hydraulic binder by means of a second facing material.

27. The production line for boards based on hydraulic binder according to claim 14, wherein the hydraulic binder comprises plaster.

28. A device for the introduction of laths onto a facing material, the device comprising:
a lath magazine;
a least one lath,
means for extracting one lath at a time from the laths magazine
means for receiving the extracted lath;
means for displacing the extracted lath in a direction parallel to its length;
means for supporting the displaced lath; and
means for moving the displaced lath in a direction parallel to its width;
the device also comprises means for coating with glue at least a part of the upper face of a lath.

29. The device according to claim 28, characterized in that wherein:
the means for receiving the extracted lath include an inclined surface fitted in its lower part with a rim;
the means for supporting the displaced lath in an inclined position include an inclined surface fitted in its lower part with a rim and on one side with a stop.

30. The device for the introduction of laths onto a facing material, the device comprising:
a lath magazine,
at least one lath;
means for extracting one lath at a time from the lath magazine
means for supporting the lath; and
means for accelerating the lath up to approximately the speed of the facing material and means for accompanying the lath during its passage into the die.

31. The device according to claim 30, in which the means include fingers arranged on a motorized belt.

32. The device according to claim 30, in which the means include an inclinable surface, preferably fitted in its lower part with a rim, said inclinable surface being able to occupy an inclined position and an approximately horizontal position.

33. The process according to claim 1, wherein the said lath has a thickness ranging from 1.5 to 4 mm.
